(19) United States
(12) Patent Application Publication
(10) Pub. No.: US 2001/0051892 A1
(43) Pub. Date: Dec. 13, 2001

(54) Method for scheduling appointments

(76) Inventor: David Brown, Tempe, AZ (US)

Correspondence Address: Garth Janke, BIRDWELL, JANKE & DURANDO, PLC, 900 SW Fifth Avenue, Suite 1925, Portland, OR, 97204, US

(21) Appl. No.: 09/916,729

(22) Filed: Jul. 26, 2001

(51) Int. Cl. G06F 17/60

(52) U.S. Cl. 705/9; 345/751; 707/104.1

(57) ABSTRACT

A method for scheduling appointments. An interactive video display connected to a computer located at an Internet web site. The computer causes the display to show all or a selected portion of a selected calendar unit of time, partitioned in one dimension, into a plurality of time-slots for scheduling appointments, and partitioned in another dimension, by each of a plurality of consultants with whom the appointments are to be scheduled. A client clicks within the space associated with both one or more desired time-slots and a desired consultant to schedule an appointment with the desired consultant during the desired time. The computer responds by updating the display to show that the selected time-slot in the selected set of time-slots has been scheduled and is no longer available.

### BACKGROUND OF THE INVENTION

The present invention relates to a method for scheduling appointments, particularly appointments made by clients of home builders for meeting with consultants who assist the client or customer to select fittings or materials for a new home.

“Design centers” currently serve the need to assist the clients of home builders to identify and specify fittings and materials, such as tile, carpet, vinyl, blinds, cabinets, lighting, plumbing, paint color, etc., for constructing or finishing the construction of the client's new home. The design centers typically provide a “show room” for display of various options available to the client, as well as marketing and technical information for the products and services of suppliers. Typically, a number of design consultants staff the design center. The consultants are available by appointment to meet with the client, discern and discuss the client's objectives, and advise or assist the client to find the appropriate products or services. The design center is often provided or supported by the builder, but this is not necessary.

Presently, appointments are made with the design consultants in the standard manner of calling the design center and speaking with someone who has access to a calendar listing the time-of-day availability for each consultant in the design center. The calendar is typically a paper record of previously scheduled appointments, and the remaining available time slots are apparent by inspection. The method has well-known drawbacks, such as the difficulty of accurately maintaining and timely updating a single paper record for a number of different consultants, and the typical requirement to employ an additional person to maintain the record.

Accordingly, there is a need for a novel and improved method for scheduling appointments that provides for decreased labor requirements, increased ease and accuracy of appointment scheduling, and improved timeliness of record keeping therefor.

### SUMMARY OF THE INVENTION

The method for scheduling appointments of the present invention solves the aforementioned problems and meets the aforementioned needs by providing an interactive video display connected to a computer located at an Internet web site. The computer causes the display to show all or a selected portion of a selected calendar unit of time, partitioned in one dimension into a plurality of time-slots for scheduling appointments, and partitioned in another dimension into a plurality of consultants with whom the appointments are to be scheduled. For example, the time-slots may be time-ordered in rows and the consultants may be represented by respective columns.

A client clicks within the space associated with one or more desired time-slots and a desired consultant to schedule an appointment with the desired consultant during the desired time. The computer responds by updating the display to show that the selected time-slot in the selected set of time-slots has been scheduled and is no longer available. Preferably, this step includes coding the time-slot with a predetermined color for uniquely identifying the selected consultant.

The computer is preferably adapted to selectably provide displays of a selected calendar month, a selected calendar week, or the working portion of a selected calendar day providing for operation as aforedescribed.

Therefore, it is a principal object of the present invention to provide a novel and improved method for scheduling appointments.

It is a further object of the present invention to provide a method for scheduling appointments that provides for decreased labor requirements.

It is still a further object of the present invention to provide a method for scheduling appointments that provides for increased ease of appointment scheduling.

It is yet a further object of the present invention to provide a method for scheduling appointments that provides for increased accuracy of appointment scheduling.

It is another object of the present invention to provide a method for scheduling appointments that provides for improved timeliness of record-keeping for appointment scheduling.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is a schematic of a network for use according to the present invention.

FIG. 2 is a flow-chart of a client intake portion of a method for scheduling appointments according to the present invention.

FIG. 3 is a video display for use by clients for scheduling appointments according to the present invention, for client data entry.

FIG. 4 is a flow-chart of a scheduling methodology for scheduling appointments according to the present invention.

FIG. 5 is a video display for use by clients for scheduling appointments according to the present invention, showing a calendar month.

FIG. 6 is a video display for use by clients for scheduling appointments according to the present invention, showing a portion of a calendar day.

FIG. 7 is one alternative configuration of the video display of FIG. 6.

FIG. 8 is a video display for use by clients for scheduling appointments according to the present invention, showing a calendar week.

FIG. 9 is a video display for use by clients for scheduling appointments according to the present invention, showing a portion of a calendar day.

FIG. 10 is a video display for use by administrators for scheduling appointments according to the present invention, showing a portion of a calendar day.

FIG. 11 is a video display for use by administrators for scheduling appointments according to the present invention, for “communities” data entry.

FIG. 12 is a video display for use by administrators for scheduling appointments according to the present invention, for “consultant” data entry.

FIG. 13 is a video display for use by administrators for scheduling appointments according to the present invention, for “report” data entry and output.

### DETAILED DESCRIPTION OF THE INVENTION

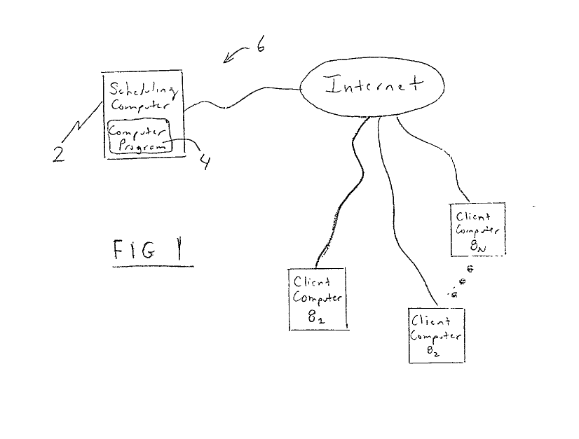

The present invention provides interactive displays for scheduling appointments. Referring to FIG. 1, the displays are preferably provided on client computers in the form of one or more web pages produced by a computer 2 adapted as directed by a computer program 4, the computer being connected to the Internet at a predetermined web site 6a, or communicating through the Internet with a predetermined web site 6b. There may be one or more (“N”) client computers 8i (i=1, 2, . . . N), which may be, e.g., PC's. The displays are interactive in the standard manner of having control and features operable by mouse or touch-screen, and permitting entry of data from a keyboard or by voice in specified locations on the display. The displays may be adapted for interaction according to future developments in personal or other client computing systems without departing from the principles of the invention.

The preferred context for the invention is to provide for scheduling appointments by clients of home builders with design center consultants or other staff members (“consultants”) who assist the client or customer to select fittings or materials for a new home. However, this context is not essential to the invention, which may be employed in any environment and for any purpose for which it is suitable. The invention is particularly advantageous for use where there are a plurality of consultants.

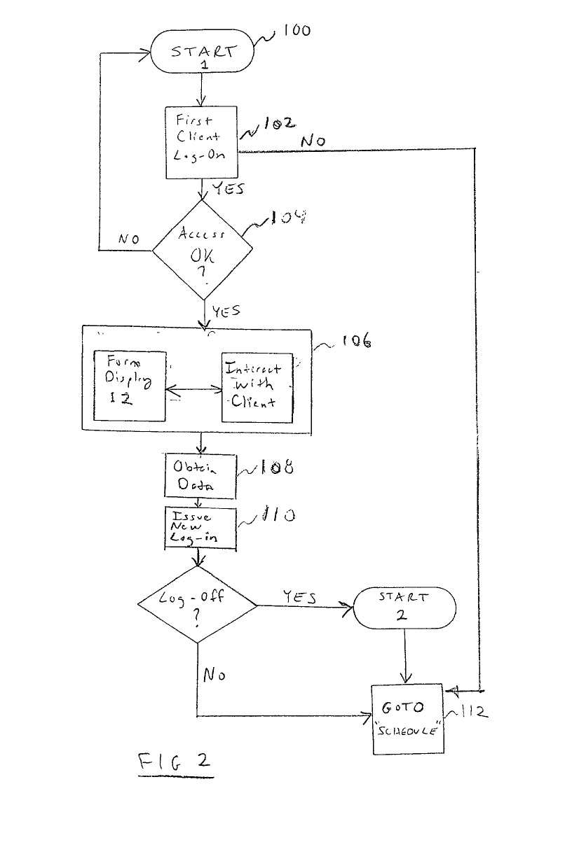

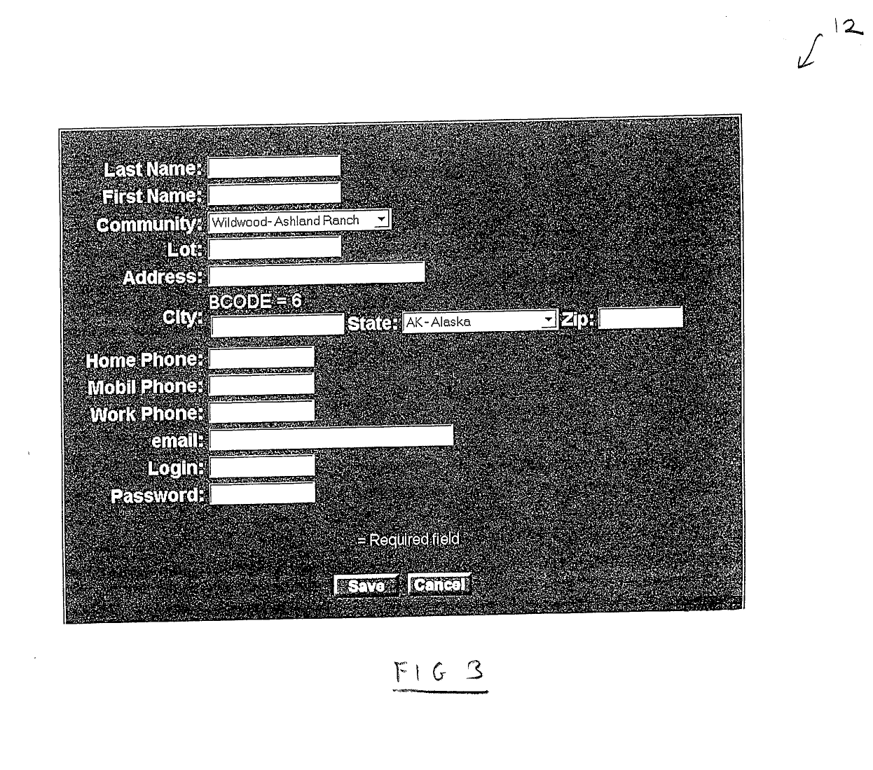

Referring to FIG. 2 showing a flow chart of a client intake portion of a method for scheduling appointments according to the invention, the web site is preferably adapted for first access 100 by the client's logging-on with a log-on identification and password that is provided to the client by the host at 102. Once the client is granted access (104) by the computer 2 (FIG. 1), the computer produces a client intake display 12 (FIG. 3) for interacting with the client to obtain client and matter identification data (106). Once the requested identification data is obtained (108), the computer may issue a new log-on identification and/or password (110). The amount of identification that is required from the client before proceeding is predetermined at the computer program 4. The client may either continue to navigate the displays provided by the program 4 through a “schedule” portion of the program (112), or log-off and log-on again to reach the step (112).

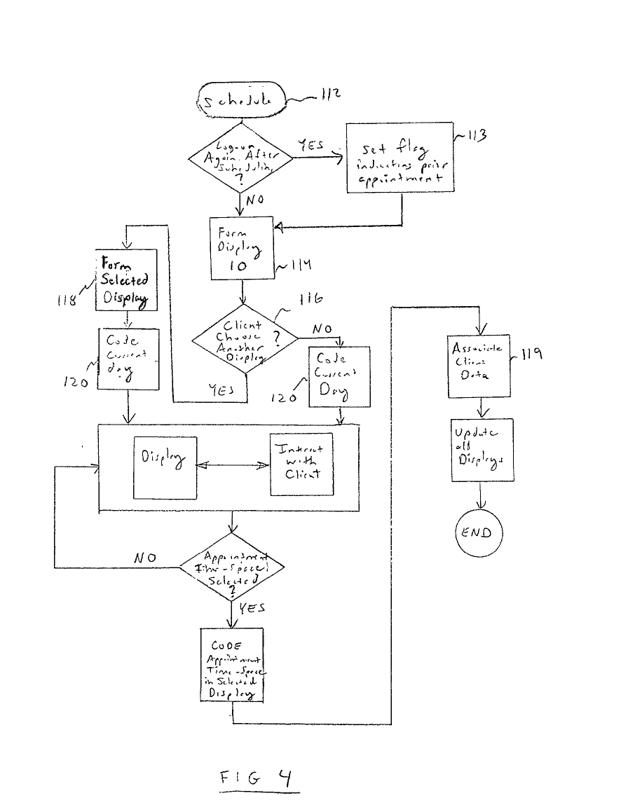

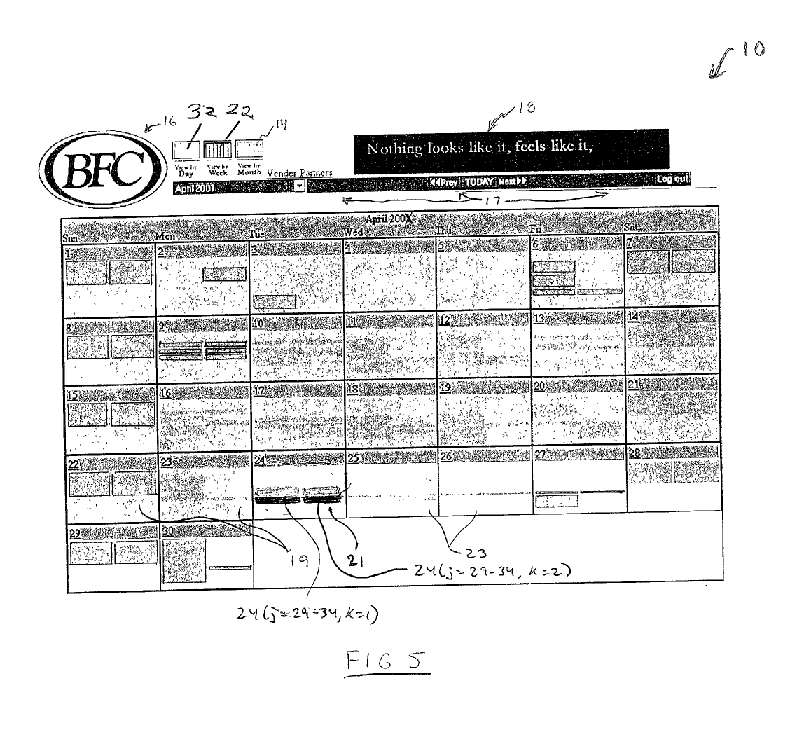

With reference to the flow-chart of FIG. 4 and the display of FIG. 5 the computer produces a predetermined initial client display 10 (114), here representing a calendar month, showing days organized in the standard manner as unit cells of a grid progressing in date order wherein the seven days of the week are represented by respective columns. The calendar month display is often preferable as the initial display because it provides an overview of a relatively large amount of time. The client may select another display from the display 10 by clicking “view by week” or “view by day” icons 22 and 32, respectively (116), wherein the computer 2 produces the selected display (118). If another display is used as the initial display, the display 10 may requested by clicking a “view by month” icon 14 on the display.

The display 10 and other displays used herein preferably show indicia 16 for identifying the sponsoring builder, such as the trademark or logo of the builder, and may include indicia identifying the design center if the design center represents more than one builder. One or more “banner ads” 18 may be sold to advertisers of products or services which may be of interest to the clients in the context of subjects of discussion with the consultants, or which may be promoted by the consultants.

At the time of client log-on, such as Tuesday, April 24, 200X, the computer produces the display 10 with updated information wherein days of the month which have elapsed are coded in a manner to contrast the current day and from future days (120). Coding is preferably carried out by providing a background for the unit cells, the background preferably being colored or shaded. For example, elapsed days 19 may be coded with one color or shading, the current day 21 may be coded with another color or shading, and future days 23 may be coded yet another color or shading. Alternatively, elapsed days may be coded with one color or shading, and present and future days may be coded with another color or shading. One of the codes may be the absence of color or shading and elapsed days may be omitted entirely from the display. Persons of ordinary skill will appreciate that there are many coding schemes that may be used to visually contrast one day or time from other days or times in a display.

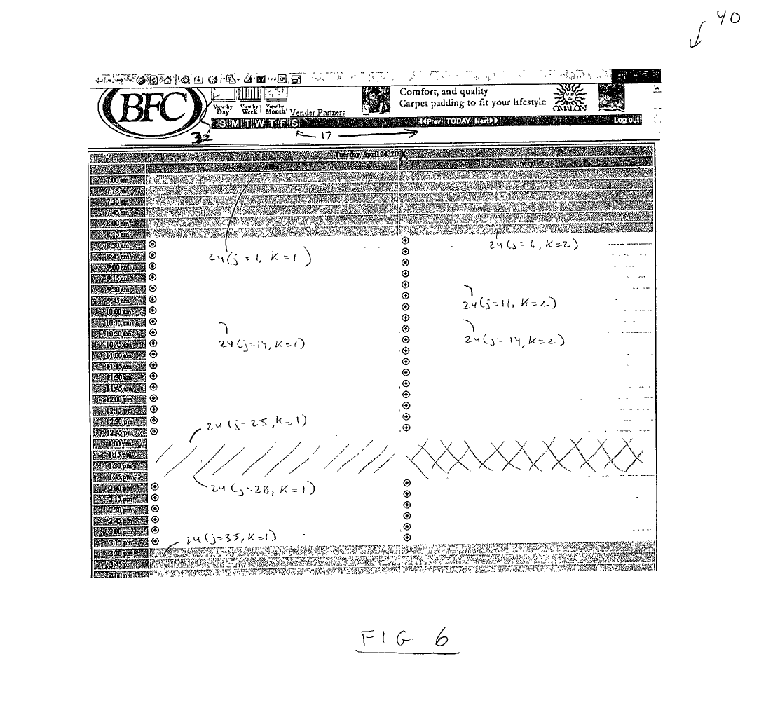

FIG. 6 shows a client display 20 for the calendar day of Tuesday, April 24, 200X, corresponding to the same day as it appears in FIG. 5. The display 20 may be reached from another display or may be selected as the initial client display when setting up the computer program 2. The particular day displayed may be selected automatically by the computer as the day of log-on, here, April 24. The day may be selected by clicking on or within the space representing the same day in the display 10 in FIG. 5. The day may also be selected by clicking on the “view by day” icon 32 in FIG. 5 to display the current date and using the control bar 17 to step the date backward or forward from the current date, or may be selected by a similar process from another display.

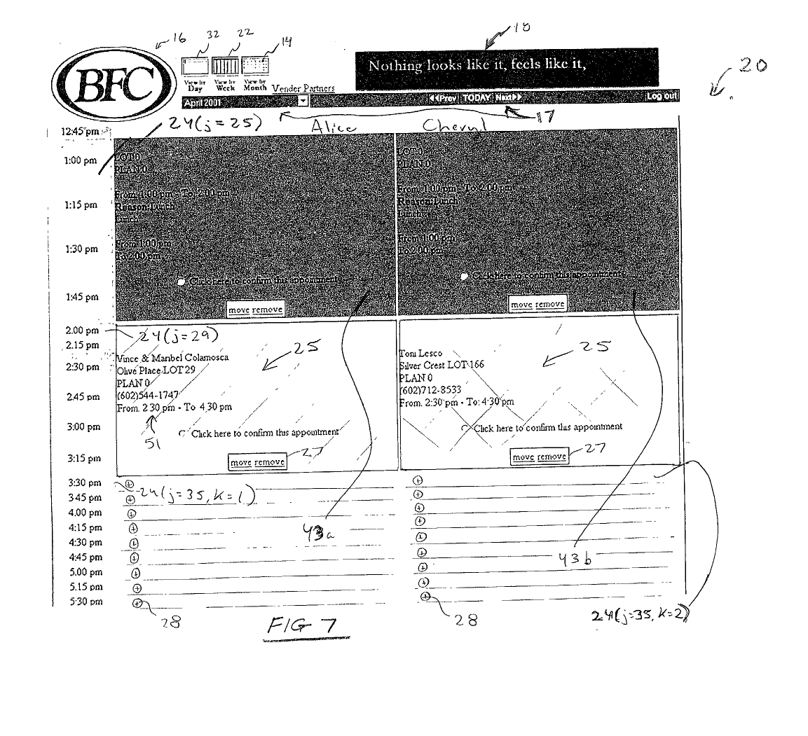

Turning to FIG. 7, another example of the client display 20 representing a portion of a calendar day is shown. The computer 2 preferably displays an entire working day; however, a lesser portion of the day may be displayed as shown and provision provided in the display for scrolling to or otherwise selecting remaining portions of the day for display.

For any of the displays, the day is divided or partitioned in two dimensions, one dimension corresponding to time and the other dimension corresponding to the identity of the individual consultants. Preferably, these dimensions are represented by rows and columns, respectively, of the display 10; however, the dimensions need not be orthogonal and the associations may be alternatively selected to suit any purpose without departing from the principles of the invention.

The time dimension is divided into time-slots 24(j), j=1, 2, . . . J, which are typically half-hour increments of time but may be of different or varied lengths. The time-slots 24(j) span the time-space corresponding to a workday; for example, there are J=16 half-hour time-slots 24 in the eight-hour time-space corresponding to a workday beginning at 8:00 AM and ending at 5:00 PM. The time-space represents time that is theoretically available for scheduling an appointment.

The consultant dimension is divided into k parts, where k=1, 2, . . . K, corresponding to each of K consultants. The Figures illustrate the circumstance wherein K=2 consultants and therefore there are two columns per day; however, there may be only one consultant without departing from the principles of the invention, and there may be more than two consultants represented by the display 20, in which case the invention provides for even greater advantage.

To combine the two dimensions, the time-slots 24(j) may be reproduced “k” times to form time-slots 24(j, k), or equivalently each time-slot 24(j) may simply be partitioned into “k” parts. Either mode of combination is referred to herein as resulting in “k” sets of time-slots, so that a time-slot 24 is identified uniquely by time and by consultant. For example, FIG. 7 shows one 15 minute time-slot 24 (j=35, k=1) from 3:30 PM to 3:45 PM for one consultant, e.g., Alice (k=1), and a corresponding 15 minute time-slot 24(j=35, k=2) for another consultant, e.g, Cheryl (k=2), where j=1 is arbitrarily selected to represent the time-slot beginning at 7:00 AM.

The computer program is adapted so that clicking within a desired time-slot, or preferably clicking on a “+” icon 28 associated with the desired time-slot, codes the time-slot 24 (j, k) to indicate that the time-slot is taken. Such coding is preferably carried out by removing the “+” icon from the display, and providing a background for the time-slot, the background being colored or shaded, preferably to distinguish the time-slots corresponding to one consultant from the time-slots corresponding to other consultants.

For example, all time-slots corresponding to Alice may be coded with one color corresponding to Alice (k=1), and all time-slots corresponding to Cheryl may be coded with another color corresponding to Cheryl (k=2). The colors or other coding should contrast with coding used for the unit cells as discussed above and are preferably unique to each consultant. Where coding is by color, contrast can be achieved by altering the hue or value of the color. Where coding is by shading, contrast can be achieved by altering the darkness or lightness thereof Where coding is implemented by using symbols, the symbols should be visually distinct. Coding used for time-slots should also be visually distinct from coding provided for the unit cells as discussed above.

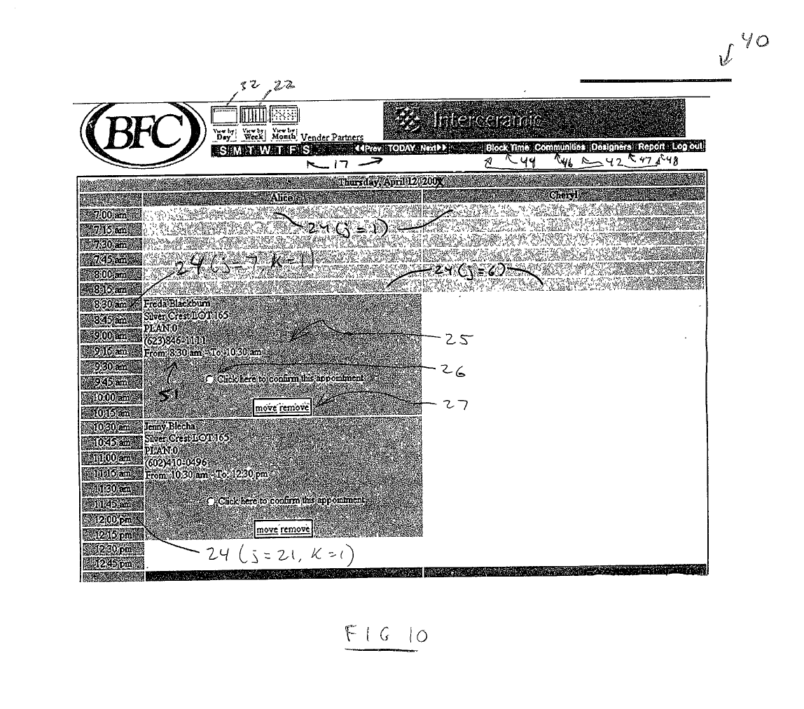

As an example, the display 20 of FIG. 7 shows twelve 15 minute time-slots 24(j=29-34, k=1) and 24(j=29-34, k=2) that have been highlighted such as by coloring, shading or coding, representing scheduled appointments for Alice and Cheryl respectively from 2:00 PM to 3:30 PM. These time-slots can also be seen in the calendar month display 10 of FIG. 5. While the time-slots are shown cross-hatched in contrasting patterns in FIG. 7 to illustrate the concept, the two time-slots are preferably colored in contrasting colors. For example, the time-slots for Alice could be colored tan and the time-slots for Cheryl could be colored green, while the remaining space of the unit cell representing April 24th on the display 10 could be white or could be colored or shaded gray. Adjacent time-slots for scheduling appointments may be maintained as discrete entities, such as shown for 24 (j=1-6) in FIG. 10 (discussed below), but are preferably coded continuously or seamlessly to form a single, uniform appointment time-space such as the time-spaces from 8:30 AM to 10:30 AM for Freda Blackburn, and 10:30 AM to 12:30 PM for Jenny Blecha.

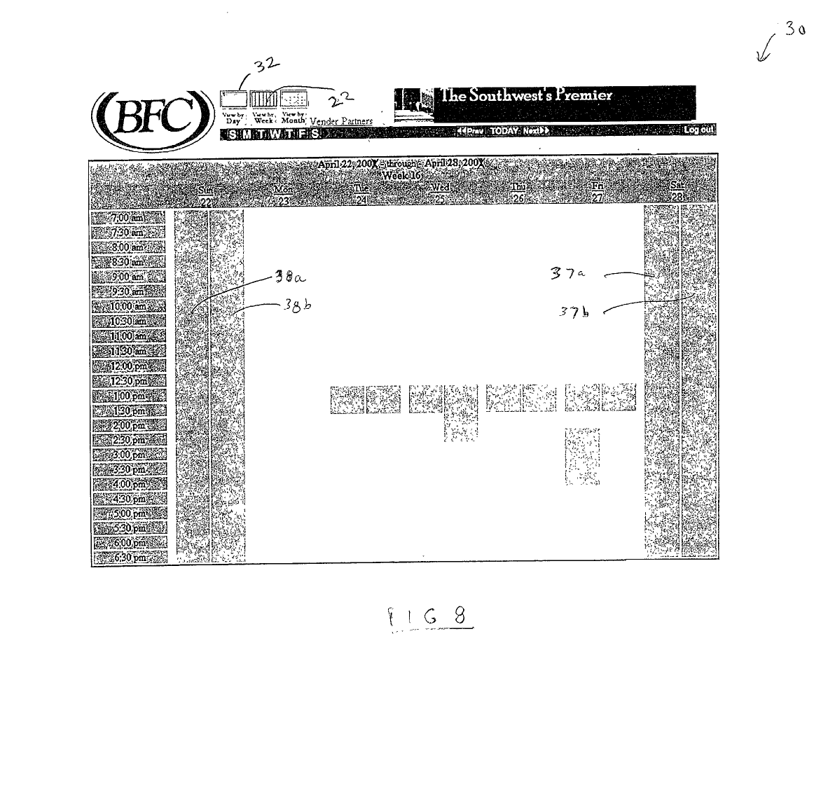

Turning to FIG. 8, another client display 30 showing a calendar week may be selected by clicking on a “view by week” icon 22 or, like any of the displays, may be produced as the initial display. The display 30 is similar to the displays 10 and 20 in that days and time-slots are coded to indicate their status. In FIG. 8, Saturday (and Sunday) shows continuous or seamlessly coded time-slots 37a, 37b (and 38a, 38b) for Alice and Cheryl, respectively, that span the entire available appointment time-space representing a work-day.

Clients may be programmatically limited to selecting a single time-slot for an appointment; however, preferably, the computer program is adapted to interpret a clicked time-slot to extend a predetermined number of time slots from the clicked time-slot, to schedule appointments of predetermined length that may vary from the length of the time-slots. For example, clicking a 3:30 PM time-slot in FIG. 6, i.e., 24 (j=35), may be interpreted by the computer program as scheduling an appointment from 3:30 PM to 4:30 PM (24(j=35-8)), or could be interpreted to span some other predetermined sequence of adjacent time-slots that includes the selected time-slot. Alternatively, the time-slots may simply be chosen to equal the predetermined length of a single appointment.

The computer program may also be adapted to permit clients to click separately on the adjacent time-slots to customize the appointment time-space. The computer may be adapted to recognize clicking in multiple time-slots by the same client, or clicking in one of the time-slots and dragging over the remaining time-slots to permit scheduling by the client of a customized appointment time-space that exceeds the duration of a single time-slot.

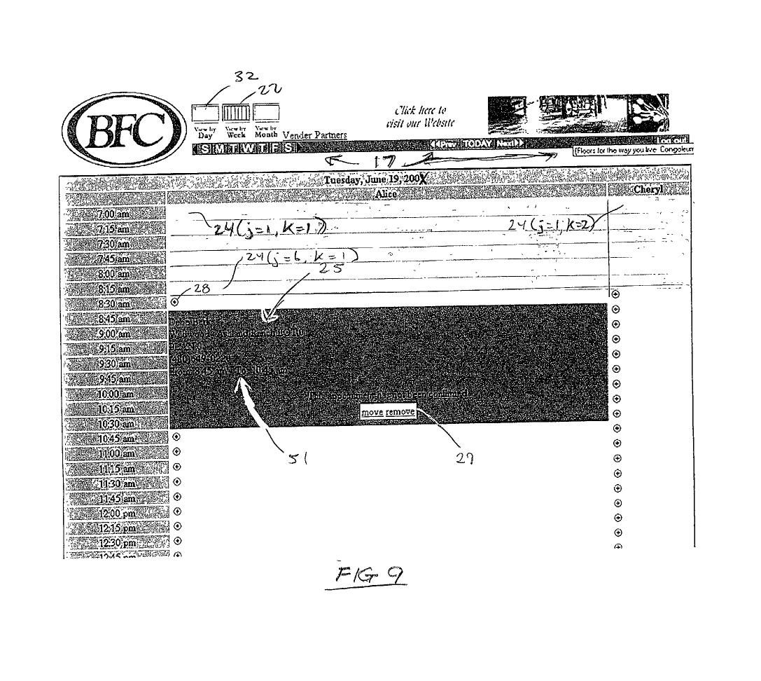

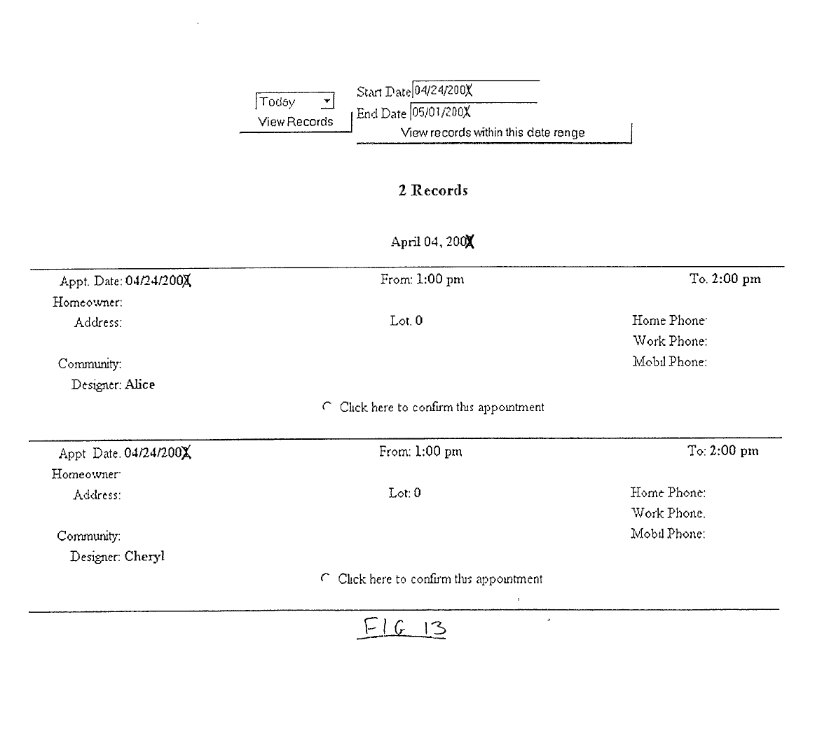

The computer program includes a standard database, to associate the available information about the client (step 119 in FIG. 2), such as the information provided in connection with FIG. 3 as mentioned above, with the time-slot or appointment time-space selected by the client. This association may be used for showing client information in the appointment time-space display (see FIGS. 9 and 10 and the associated discussion below), or for generating reports for use by the consultants or others interested in tracking either past or future usage of the consultant's time (see FIG. 13 and the associated discussion below).

A client who has once scheduled an appointment may subsequently decide to change the appointment, either by canceling the appointment or moving it to another set of time-slots. The computer program is preferably adapted to recognize when a client who has already scheduled an appointment logs-on again (FIG. 2, step 102). With reference to FIGS. 4 and 9, the computer 2 sets a flag (113) in that circumstance, and may add to the display, e.g., at step 114, client and other identifying information 25, such as the name and phone number of the client and the lot or location identification of the property (from step 106 in FIG. 2), the time and duration of the appointment 51 (FIGS. 7 and 9), and a “move/remove” icon 27 in the appointment time-space that was previously selected by the client.

Clicking “move” preferably causes the computer program to re-code the appointment space, e.g., by changing its color from green to red in anticipation of the client's selection of a new day and time. When the client obtains the new day and time in the manner described above, clicking on the desired time-slot deposits the information previously assigned to the previously selected appointment time-space into the new appointment time-space. The new appointment time-space is then coded appropriately and all coding is from the previously selected appointment time-space is extinguished. Clicking “remove” simply extinguishes the coding from the previously selected appointment time-space.

It may be noted that the time-slots 24 include, in addition to the indices “j” and “k” for the day display 20, a day index for identifying a particular day in the calendar week display or in the calendar month displays. As mentioned previously, a particular day may be selected from the calendar month display 10 (FIG. 5) by clicking on or within the day as displayed, or clicking on the “view by day” icon 32 and using the control bar 17. The day may also be selected from the display 30 by the same operations. Selecting the day sets the day index.

Described so far are displays and operations accessible by clients. Correspondingly similar displays are also provided which are accessible by consultants and administrators of the design centers, or which may be solely accessible by one or the other (collectively “administrative displays”). FIG. 10 provides an example. An administrative display 40 corresponding to the client display 20 shows a scheduled appointment time-space consisting of eight time-slots 24(j=7, 8, . . . 14, k=1), spanning the time-space 8:30 AM to 10:30 AM (scheduled by Freda Blackburn for meeting with Alice), and another scheduled appointment time-space consisting of eight more time-slots 24(j=15, 16, . . . 22, k=1) spanning the time-space 10:30 AM to 12:30 PM (scheduled by Jenny Blecha for meeting with Alice).

The display 40 provides client identifying and other information 25, such as the name and phone number of the client and the lot or location identification of the property (step 106 in FIG. 2), the duration of the appointment 51, and an administrative tool-bar 42. The display 40 informs consultants about the clients with whom they are scheduled to meet, which facilitates determining whether to agree to the meeting as well as preparing for the meeting. Regarding the former, the computer program preferably provides, in the display 40, a clickable icon 26 for the consultant to register or indicate confirmation of the appointment, and another clickable icon 27, similar or identical to that mentioned above for clients who have logged-on again after having scheduled their appointments, for removing the appointment from the calendar or moving it to another set of time-slots. Preferably, according to the invention, confirmation by the consultant includes sending an e-mail to the client, or phoning the client, to convey the fact of confirmation. However, the program 4 may also be adapted to provide one or more of the client displays with a confirmation signal, code or other indication in the appointment time-space.

Referring back to FIG. 7 showing a client display 20, in yet another aspect of the invention time-slots may be “blocked out” by the consultants or other administrators of the design center as being unavailable for predetermined reasons, such as lunch hour, the reasons preferably also being included in the information 25 shown in the display. Time-slots 24 that are blocked out are preferably coded in both the client and administrative displays in a manner to distinguish them from scheduled appointments. For example, slots 24 (j=25-28, k=1, 2) identify respective hour-long blocks of time 43a, 43b for Alice and Cheryl. The blocks of time 43 may be coded blue for both consultants to indicate that the time is blocked out rather than scheduled for an appointment, the blue color contrasting with the tan and green codes used for scheduled appointment time-slots for Alice and Cheryl.

Returning to FIG. 10, to permit consultants to block time as just described, the administrative display 40 provides a tool-bar 42 that includes a clickable “block time” icon 44 for selecting and deselecting this mode of operation.

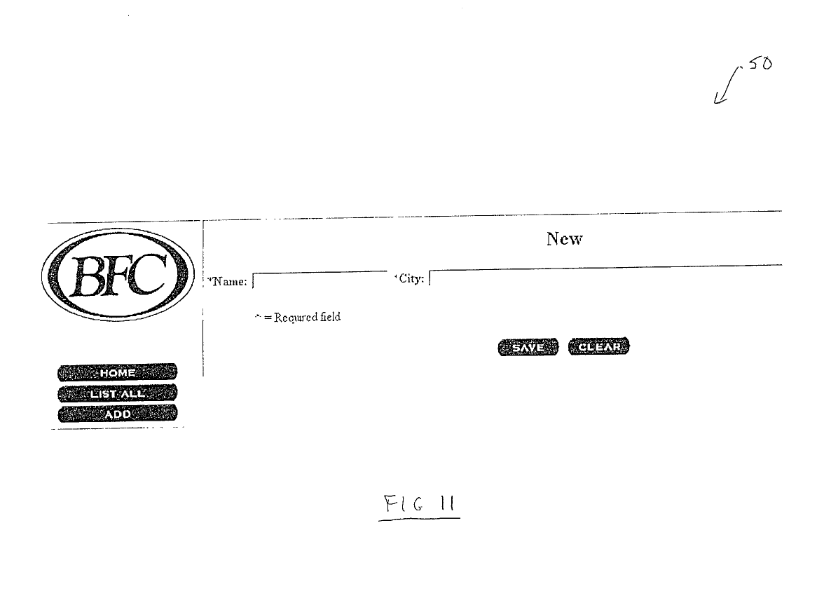

Referring to FIGS. 10 and 11, the tool-bar 42 also preferably includes a clickable “communities” icon 46 which causes a display 50 to appear wherein the name and city of new communities or sub-divisions in which the builder is building can be input to and stored by the computer program.

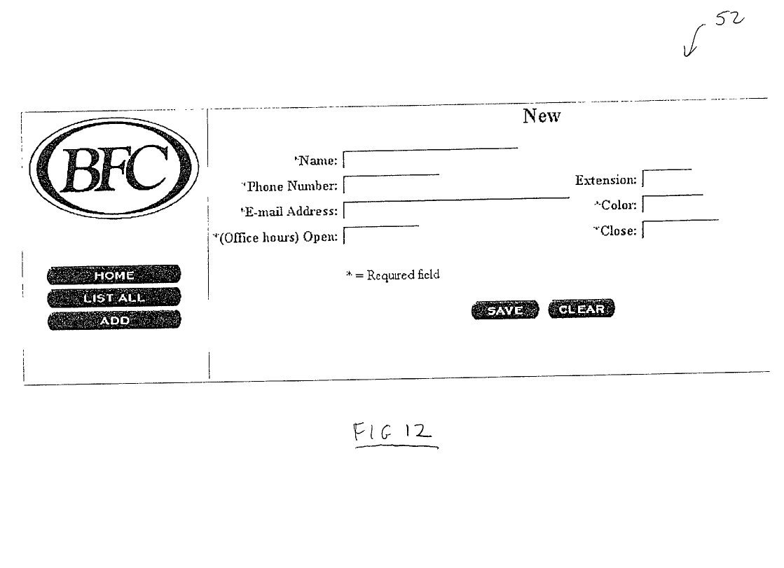

Referring to FIGS. 10 and 12, the tool-bar 42 also preferably includes a clickable “designers” (or “consultants”) icon 47 which causes a display 52 to appear wherein consultant information, such as name, phone number, e-mail address, office hours, and color code for purposes of display can be input to and stored by the computer program.

Referring to FIGS. 10 and 13, the tool-bar 42 also preferably includes a clickable “report” icon 48 which causes a display 54 to appear wherein time and date information may be input to the computer program and appointment information may be output by the computer program in response.

For any of the displays, the appointment time-space as displayed may be increased in size to accommodate all of the aforementioned information 25, the icons 26 and 27, and instructions for using one or more of the icons. Examples of this are shown in FIG. 6, wherein four 15 minute time-slots 24 (j=25-28, k=1) and four 15 minute time-slots 24 (j=25-28, k=2), corresponding to Alice's and Cheryl's lunch hours respectively, and wherein four (24(j=31-34, k=1,2)) of the six time-slots 24 (j=29-34, k=1,2) corresponding to Alice's appointment with Vince and Maribel Colamosca and Cheryl's appointment with Toni Lesco, are shown enlarged with respect to time-slots 24 (j=29-30, k=1,2) and 24 (j=35-43, k=1,2).

Also, the program 4 provides for adjusting the calendar day displays to reflect beginning times of the work day that are later than a predetermined earliest time, and ending times of the work day that are earlier than a predetermined latest time. An example of this provision is shown in FIG. 9 by grey coded time-slots 24(j=1-6, k=1,2), corresponding to the time-space starting with a predetermined earliest time for the start of the work day of 7:00 AM and ending at an actual 8:30 AM beginning of the consultants' work day, which is also preferably indicated by employing in the remaining available time-slots the aforementioned “+” icon 28 for scheduling appointments associated with the available time-slots. An analogous treatment is provided at the end of the work day, which although it does not show in the Figure, may have a predetermined latest ending time of 5:00 PM, but which may show “unavailable” time-slots for both consultants between 4:00 PM and 5:00 PM.

The “unavailable” time-slots are typically more conveniently set globally in the computer program rather than administratively by the consultants using the “block time” icon, because they are typically not changed very often. It should be noted that, while in this example, Alice and Cheryl begin and end their work-days at the same time, the program 4 easily accommodates staggering the “unavailable” time-slots to reflect different starting and ending times of the work-day for the different consultants.

With the features of the computer program 4 having been described in detail, persons of ordinary skill in the art, such as web site designers, using standard and widely available tools, will be able to use these tools to implement the same or similar features.

It is to be recognized that, while a particular method for scheduling appointments has been shown and described as preferred, other methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A method for scheduling appointments by use of an interactive video display connected to a computer located at a web site on the Internet, the computer being adapted for executing a computer program for communicating with the display, the method comprising the steps of:
selecting a calendar unit of time;
causing the display to show all or a selected portion of the selected calendar unit of time;
partitioning the display in a first dimension into a plurality of time-slots for scheduling appointments;
partitioning the display in a second dimension by each of a plurality of consultants with whom the appointments are to be scheduled;
clicking within a first space associated with both (a) a first set of one or more of the time-slots and (b) a first selected one of the consultants; and
coding the clicked said space with a first predetermined code to indicate selection of said first set of one or more of the time-slots and the first selected said consultant for scheduling a first appointment.

2. The method of claim 1, further comprising confirming said first appointment by indicating confirmation.

3. The method of claim 2, wherein said step of confirming further comprises sending an e-mail to indicate confirmation.

4. The method of claim 2, wherein said step of confirming further comprises communicating by telephone to indicate confirmation.

5. The method of claim 1, further comprising clicking within a second space associated with both (c) a second set of one or more of the time-slots and (d) a second selected one of the consultants, and coding the clicked said second space with a second predetermined code contrasting with said first code to indicate selection of said second set of one or more of the time-slots and the second selected said consultant for scheduling a second appointment, and to contrast said second appointment and said first appointment.

6. The method of claim 5, further comprising confirming said first or said second appointment by indicating confirmation.

7. The method of claim 6, wherein said step of confirming further comprises sending an e-mail to indicate confirmation.

8. The method of claim 6, wherein said step of confirming further comprises communicating by telephone to indicate confirmation.

9. The method of claim 1, wherein said first dimension and said second dimensions are defined by rows and columns, respectively.

10. The method of claim 1, wherein first and second codes are colors applied to said first and second spaces.

11. The method of claim 10, wherein said colors differ in hue.

12. The method of claim 10, wherein said colors differ in value.

13. The method of claim 1, wherein said step of selecting includes selecting a calendar month.

14. The method of claim 13, further comprising coding days of said month with one or more predetermined codes contrasting with said first code.

15. The method of claim 13, wherein said step of coding days of said month codes elapsed days with a predetermined second code and codes the current day with a predetermined third code contrasting with said first code and said second code.

16. The method of claim 15, wherein said first, second and third codes are contrasting colors.

17. The method of claim 16, wherein at least two of said colors differ in hue.

18. The method of claim 16, wherein at least two of said colors differ in value.
